(19) United States
(12) Patent Application Publication
(10) Pub. No.: US 2015/0068118 A1
(43) Pub. Date: Mar. 12, 2015

(54) Post pot

(71) Applicants: Robert Shane Stewart, Pataskala, OH (US); Nicole Rene Stewart, Pataskala, OH (US)

(72) Inventors: Robert Shane Stewart, Pataskala, OH (US); Nicole Rene Stewart, Pataskala, OH (US)

(21) Appl. No.: 14/025,625

(22) Filed: Sep. 12, 2013

(51) Int. Cl. A01G 9/02

(52) U.S. Cl. CPC A01G 9/02
USPC 47/65.5

(57) ABSTRACT

A novel, improved plant support devise, that is universally adaptable for holding one or more plants. This planter's pot is specifically designed for placement upon the top of any 4×4 inch object. Examples of objects it is intended for mating with may include the top of fence posts and/or mailbox posts. Said planter's pot is architecturally designed with a 4×4 inch, introverted opening in the center of the base of the pot. When met with, for instance, the top of a 4×4 inch fence post, the planter's pot introverted internal cavity would mate with the pot. It would sit, combined with the 4×4 inch object. No additional attachment devices are needed to secure such planter pot to its base.

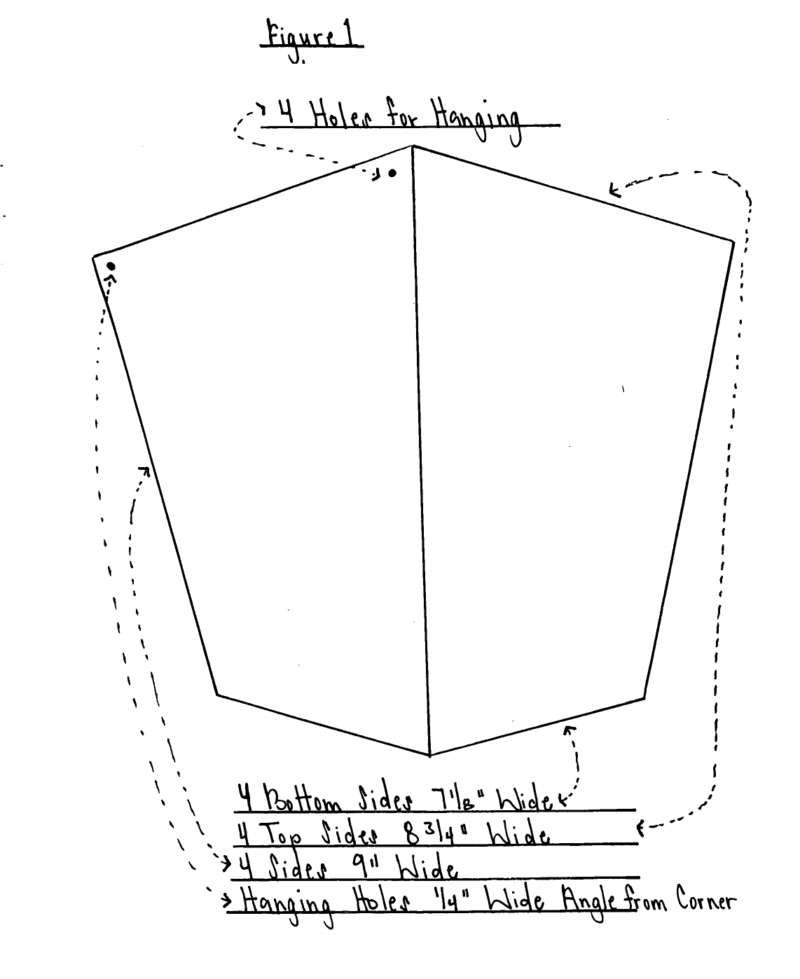

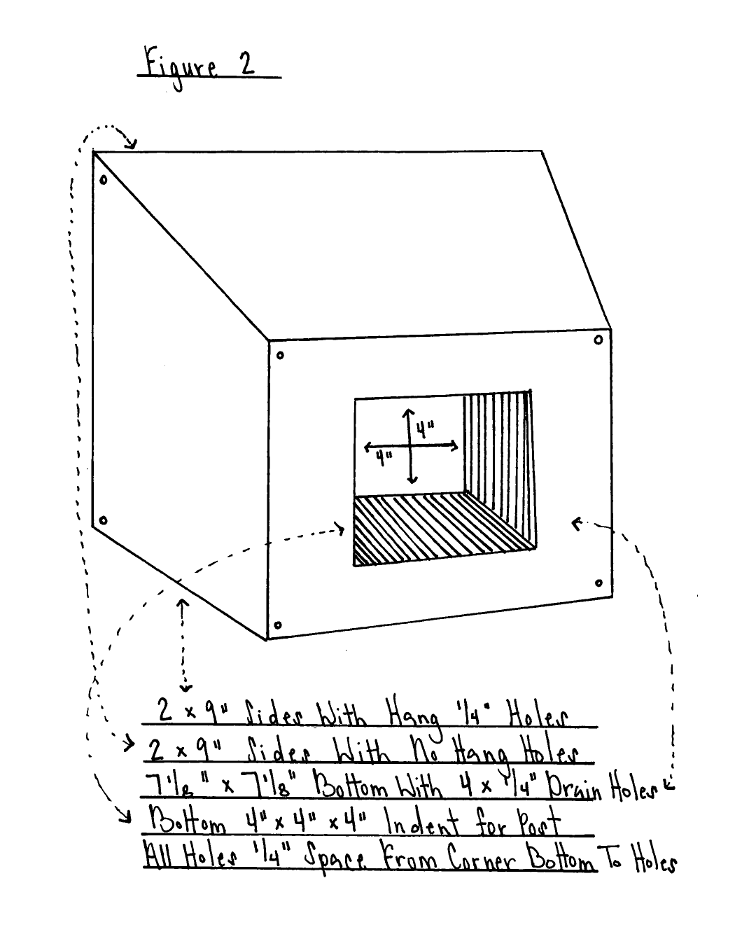

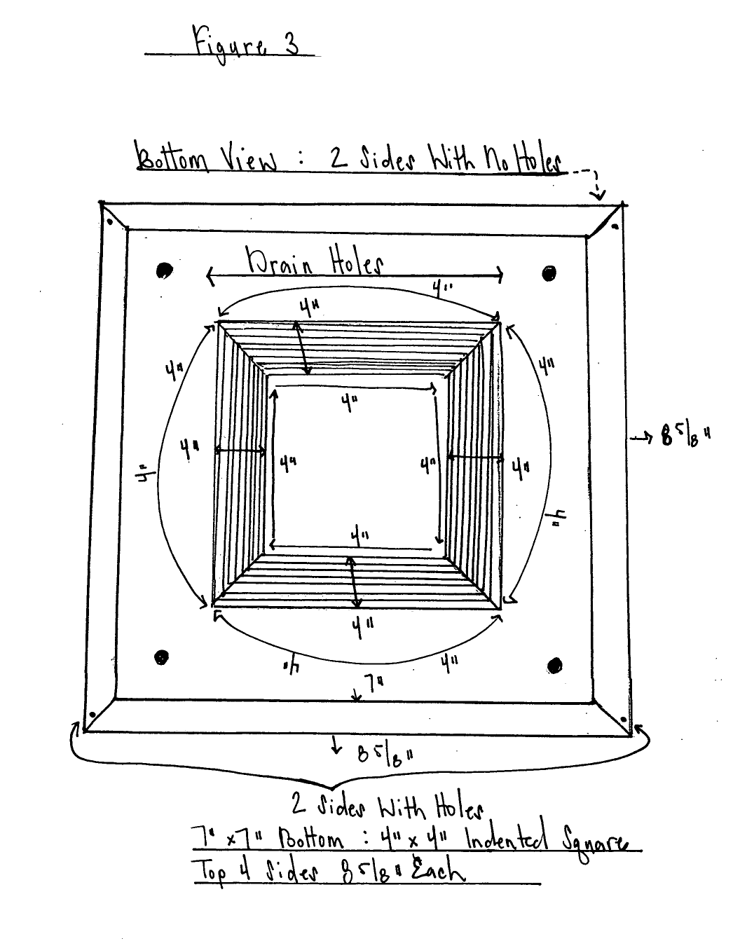

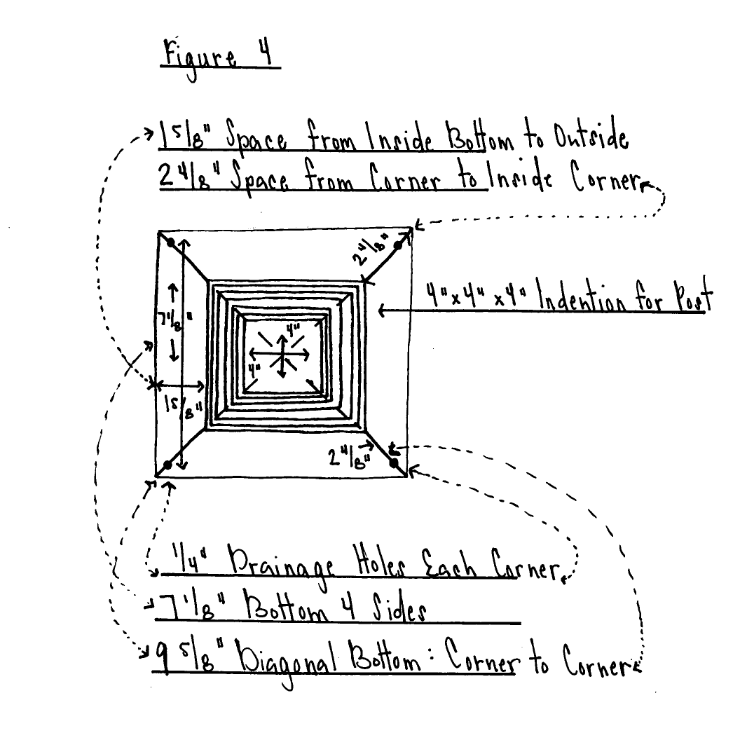

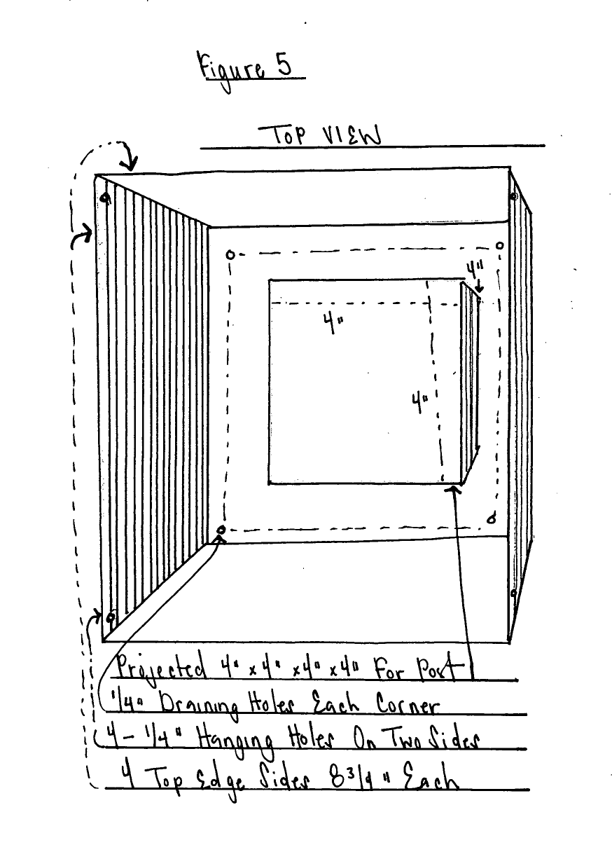

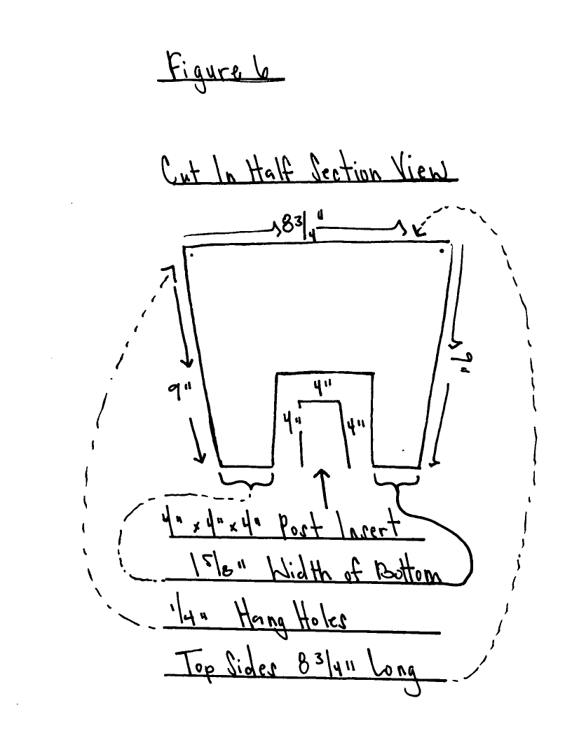

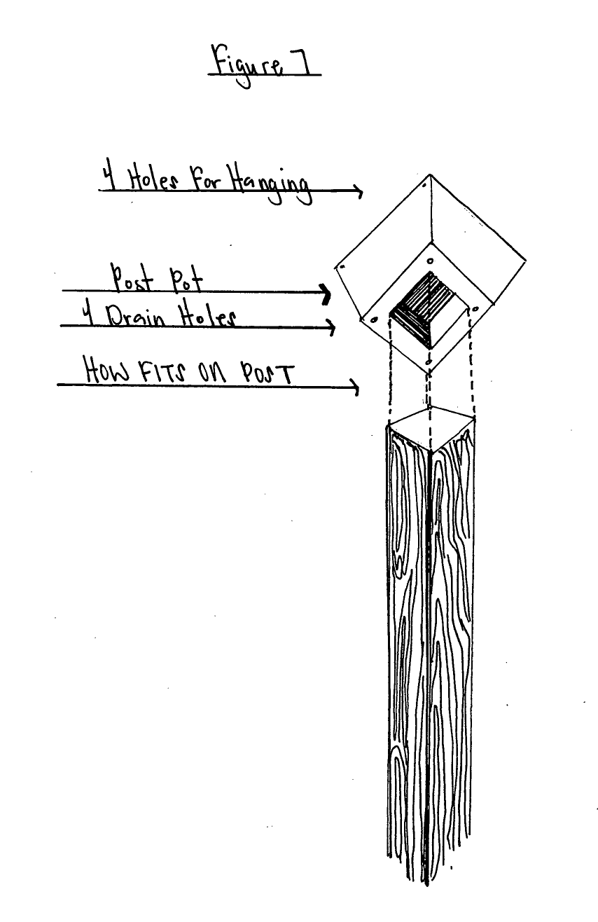

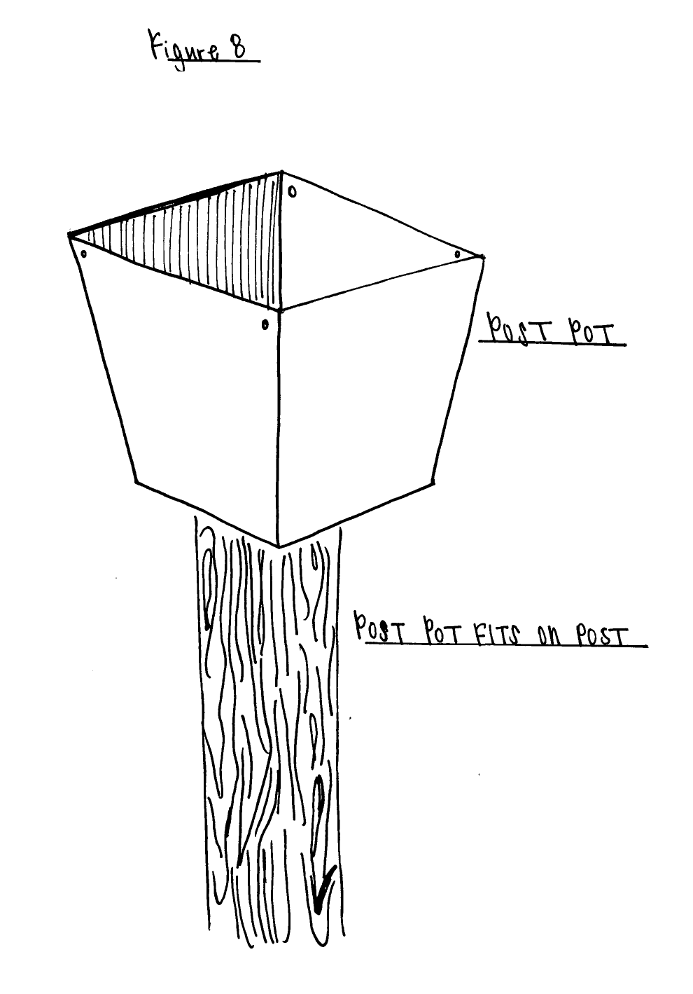

A pot specifically designed to mate with the top of any 4×4 inch object. This is shown in sheets 2 through 8. The frame is constructed of any durable material that is safe and will not degrade when exposed to the elements. Such elements may include heat, cold, wind, rain, and snow, as well as, matter such as soil and water. The Post Pot has 9″ walls that raise vertically from the bottom, 8¾″ sides (×4) that raise at an elementary level to the top, and 7×⅛″ bottom sides that convert to the inverted, raised part of the Pot which is shown in sheet 1. There are also 4×¼41 hanging holes and angles also shown in Sheet 1. Sheet 1 is a general overview of the Post Pot. Sheet 2 shows what is unique about this pot. It has an introverted 4″×4″ space that is designed to mate with any object meeting that space requirement. Sheet 3 goes into a more in depth look at its design. This sheet shows what the pot looks like from the bottom to the top. Sheet 4 also demonstrates what the Post Pot looks like from the bottom to the top. Sheet 5 shows what the pot would look like if you were looking at it from the top, seeing inside the Post Pot. Sheet 6 demonstrates what you would see if you had cut the pot in half. Sheets 7 & 8 demonstrate excellent ways that this Post Pot may be used in everyday gardens, decorations, homes, mailboxes, and any other use one sees fit.

### DESCRIPTION

Post Pot has 4 wall surfaces that are 9 inches in height. These walls are disposed parallel to one another and are placed at an outward angle. The opening at the top of the pot is 8.5×8.5 inches. The base of the pot measures 7×7 inches. Placed directly in the center of the pot is an opening. It will have a 4, ⅛ inch diameter holes, placed 1 inch from each of the corners at the base of the pot, meant to facilitate drainage of excess water. Within the pot is an introverted area. It is a 4×4 inch introverted space. It has 4 walls that are placed parallel to one another in a perpendicular lining with whatever the pot may be sitting on. The walls are each 4 inches in height and they may only be visible by looking inside the opening at the top of the pot.

Each part of the pot will be comprised of a flat, resilient plastic, or metal.

1. A planter pot that consists of an external part of the pot, as well as, an introverted internal part of the pot. The external compartment of the part is meant to hold plants, herbs, flowers, etc. The introverted internal part is meant to mate with any 4×4 inch post. Examples of posts may include, but are not limited to, a fence post, mailbox post, or garden post.

2. Introverted internal cavity is sized to receive a 4×4 inch post securely. The internal cavity is shaped in such a manner .that no other separate fastener is needed to secure the planter to the support structure.

3. There are many distinctions between the different functions of this pot. It will come in various types of decorative designs. The pot is intended to become an ornamental planting device that enables the holding of various types of plants. It may have different shapes and come in a variety of different colors. It may be made using different types of materials. It may also come in different types of designs, for example, flared edges.

4. It may be made using different types of materials. Such materials may include, but are not limited to, plastic, cooper, steel, power coated, or stainless steel.

5. Address numbers, names of families, and any other ornamental designs may be placed on the pot.

6. The pot is designed to enhance the beauty of such said objects. Objects may include a fence post, the top of a mailbox, the top of a deck railing, in a garden on a post, and may even be hung.

7. The pot may even be used as a stationary planter. It could sit on your deck, porch, and in your house.

8. This invention relates generally to the field of horticulture and the design of one's outdoor and/or indoor spaces. It enables the user to create a more fashionable landscape. It may also be used to aid with any type of amateur gardening.

9. A novel, improved plant support device, universally adaptable for holding one or more plants. As stated above, the main cavity of the pot is designed to hold many types of plants, herbs, flowers, etc. The pot has wall surfaces dispoed parallel to one another moving out at an outward angle. The roots of said types can extend into the earth of the soil placed inside the pot. This invention allows the plant to be irrigated and also allows excess water to drain out of the pot at target areas.
Invention is a new and useful improvement intended to be manufactured.
